(19) United States
(12) Patent Application Publication
(10) Pub. No.: US 2009/0138680 A1
(43) Pub. Date: May 28, 2009

(54) VECTOR ATOMIC MEMORY OPERATIONS

(76) Inventors: Timothy J. Johnson, Chippewa Falls, WI (US); Gregory J. Faanes, Chippewa Falls, WI (US)

Correspondence Address: SCHWEGMAN, LUNDBERG & WOESSNER, P.A., P.O. BOX 2938, MINNEAPOLIS, MN, 55402, US

(21) Appl. No.: 11/946,490

(22) Filed: Nov. 28, 2007

(51) Int. Cl. G06F 9/30

(52) U.S. Cl. 712/208; 712/220; 712/E09.028

(57) ABSTRACT

A processor is operable to execute one or more vector atomic memory operations. A further embodiment provides support for atomic memory operations in a memory manger, which is operable to process atomic memory operations and to return a completion notification or a result.

### FEDERALLY SPONSORED RESEARCH OR DEVELOPMENT

The U.S. Government has a paid-up license in this invention and the right in limited circumstances to require the patent owner to license others on reasonable terms as provided for by the terms of Contact No. MDA904-02-3-0052, awarded by the Maryland Procurement Office.

### FIELD OF THE INVENTION

The invention relates generally to computer system instructions, and more specifically to a computer system including vector atomic memory operations.

### BACKGROUND

Most general purpose computer systems are built around a general-purpose processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions.

In more sophisticated computer systems, multiple processors are used, and one or more processors runs software that is operable to assign tasks to other processors or to split up a task so that it can be worked on by multiple processors at the same time. In such systems, the data being worked on is typically stored in memory that is either centralized, or is split up among the different processors working on a task.

Instructions from the instruction set of the computer's processor or processor that are chosen to perform a certain task form a software program that can be executed on the computer system. Typically, the software program is first written in a high-level language such as “C” that is easier for a programmer to understand than the processor's instruction set, and a program called a compiler converts the high-level language program code to processor-specific instructions.

In multiprocessor systems, the programmer or the compiler will usually look for tasks that can be performed in parallel, such as calculations where the data used to perform a first calculation are not dependent on the results of certain other calculations such that the first calculation and other calculations can be performed at the same time. The calculations performed at the same time are said to be performed in parallel, and can result in significantly faster execution of the program. Although some programs such as web browsers and word processors don't consume a high percentage of even a single processor's resources and don't have many operations that can be performed in parallel, other operations such as scientific simulation can often run hundreds or thousands of times faster in computers with thousands of parallel processing nodes available.

The program runs on multiple processors by passing messages between the processors, such as to share the results of calculations, to share data stored in memory, and to configure or report error conditions within the multiprocessor system. Communication between processors is an important part of the efficiency of a multiprocessor system, and becomes increasingly important as the number of processor nodes reaches into the hundreds or thousands of processors, and the processor network distance between two processors becomes large.

The speed of a processor or of a group of processors at running a given program is also dictated by the instructions the processor is able to execute, and by the degree to which a particular application can make efficient use of the instructions that are available in the processor. Some instructions, for example, are specifically chosen because they enable certain types of tasks to rum more efficiently. Other instructions such as single instruction multiple data (SIMD) or vector instructions operate on multiple sets of data with a single instruction, enabling more efficient manipulation of data.

It is desirable to provide an instruction set in a processor that enables fast and efficient program operation.

### SUMMARY

One example embodiment of the invention comprises a computer system comprising an instruction decoder operable to process a vector atomic memory operation instruction. Another example embodiment of the invention comprises a memory manager for a computerized system operable to perform a vector atomic memory operation as a series of atomic memory operations.

### BRIEF DESCRIPTION OF THE FIGURES

FIG. 1 shows a block diagram of a memory manager supporting vector atomic memory operations, consistent with an example embodiment of the invention.

FIG. 2 is flowchart of a method of processing vector atomic memory operations, consistent with an example embodiment of the invention.

FIG. 3 is a state diagram illustrating a vector atomic memory cache coherence protocol, consistent with an example embodiment of the invention.

FIG. 4 is an alternate block diagram of a computerized system memory manager supporting vector atomic memory operations, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention provides for vector atomic memory operations in a processor. A further embodiment provides support for atomic memory operations in a memory manger, which is operable to process atomic memory operations and to return a completion notification or a result.

Vector instructions in processors are instructions that are able to perform operations on multiple data elements at the same time, in contrast to traditional scalar processors that operate on a single data element at a time. Most processors such as those used in personal computers and consumer electronic devices are primarily scalar processors, as vector processors are somewhat more expensive and complex. Vector processors are not uncommon in supercomputer systems, such as those used for scientific computing or other high-performance applications.

Vector operations can perform the same tasks as scalar processors, but are often must faster than scalar processors for several reasons. First, the instruction that performs the operation need only be issued and executed in the processor once, as opposed to issuing and executing a separate instruction for each element of a data vector to be similarly modified. Second, the address of the data being fetched and operated upon need only be translated or decoded once instead of one time for each data element, resulting in significant time savings. Also, the program only includes a single instruction to perform the operation on many data elements instead of a separate instruction for each data element, saving on program code size and memory and storage requirements.

Vectorization adds complexity to the processor, and typically adds a time cost to the decoding and processing of all instructions in a processor, and so is most often used only in environments where large volumes of numerical data are operated upon using the same or similar instructions. Examples include physics simulation, weather prediction, image or vide processing, or other applications where the same operation is performed on a large volume of data repeatedly to obtain a useful program result.

Some processor operations are considered atomic, in that their occurrence can be considered a single event to the rest of the processor. More specifically, an atomic operation does not halfway complete, but either completes successfully or does not complete. This is important in a processor to ensure the validity of data, such as where multiple threads or operations can be operating on the same data type at the same time. For example, if two separate processes intent to read the same memory location, increment the value, and write the updated value back to memory, both processes may read the memory value before it is written back to memory. When the processes write the data, the second process to write the data will be writing a value that is out of date, as it does not reflect the result of the previously completed read and increment operation.

This problem can be managed using various mechanisms to make such operations atomic, such that the operation locks the data until the operation is complete or otherwise operates as an atomic operation and does not appear to the rest of the processor to comprise separate read and increment steps. This ensures that the data is not modified or used for other instructions while the atomic instruction completes, preserving the validity of the instruction result.

The present invention provides in one example embodiment a new type of instruction for a computer processor, in which atomic operations on memory can be vectorized, operating on multiple memory locations at the same time or via the same instruction. This addition to the instruction set makes more efficient use of the memory and network bandwidth in a multiprocessor system, and enables vectorization of more program loops in many program applications.

Examples of atomic memory operations included in one embodiment include a vector atomic add, vector atomic AND, vector atomic OR, vector atomic XOR, vector atomic fetch and add, vector atomic fetch and AND, vector atomic fetch and OR, and a vector atomic fetch and XOR. The non-fetch versions of these instructions read the memory location, perform the specified operation, between the instruction data and the memory location data, and store the result to the memory location. The fetch versions perform similar functions, but also return the result of the operation to the processor rather than simply storing the result to memory.

There are two vector types in various embodiments, including strided and indexed vectors. Strided vectors use a base and a stride to create a vector length of the stride length starting at the base address. Indexed vector access uses a base and a vector of indexes to create a vector of the length of the indexes, enabling specification of a vector comprising elements that are not in order or evenly spaced.

Hardware implementation of the vector atomic memory operations includes use of additional decode logic to decode the new type of vector atomic memory instruction. Vector registers in the processor and a vector mask are used to generate the vector instruction, and a single atomic memory instruction in the processor issues a number of atomic memory operations. In the memory system, vector atomic memory operations operate much like scalar atomic memory operations, and the memory manager block provides the atomic memory operation support needed to execute these instructions.

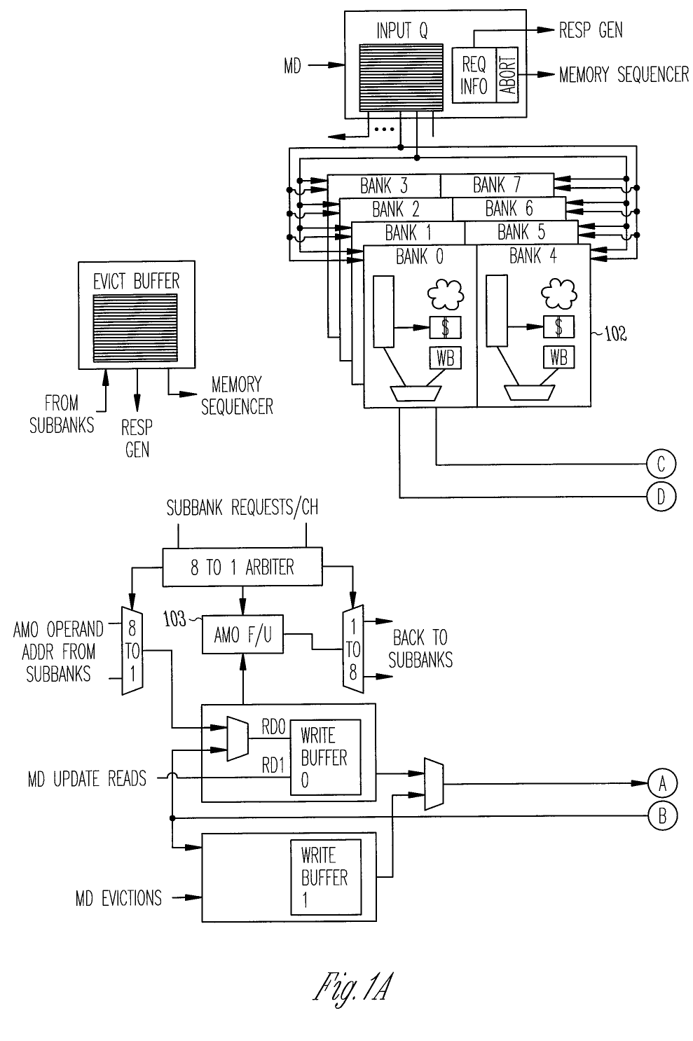

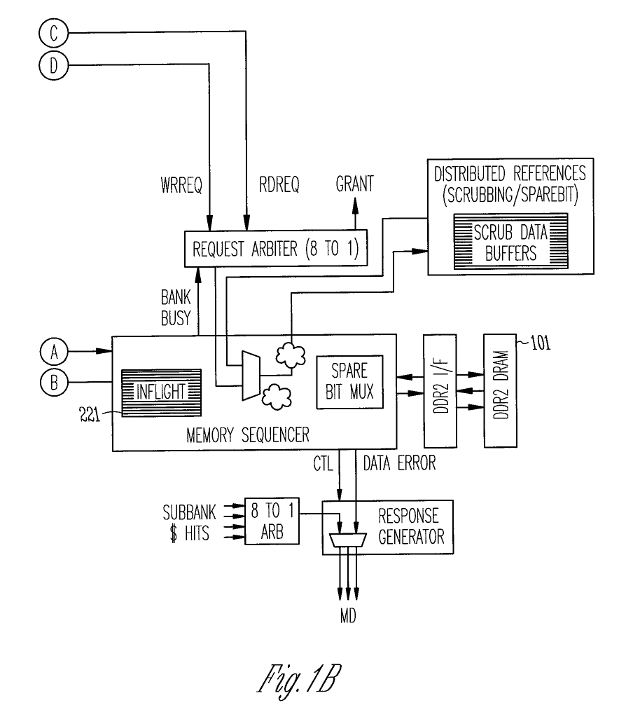

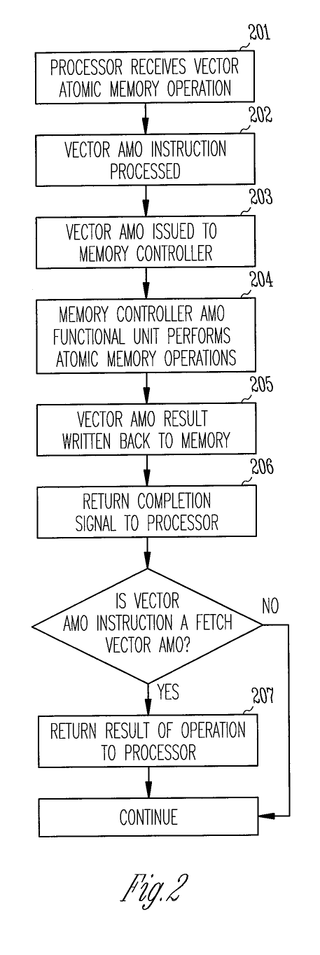

FIG. 1 shows an example of such a memory management unit operable to process a vector atomic memory operation, consistent with an example embodiment of the invention. The memory manager pictured shows a bank of double data rate dynamic random access memory at 101. The memory manager provides error correction, and an eight-word atomic memory operation buffer, and memory scrubbing to independently detect and correct single bit errors during operation. Errored memory references are automatically retried, distinguishing between a persistent an intermittent error in memory. Spare bits in memory, such as where extra bits for SECDED or ECC support are available, can be inserted to replace known bad bits in memory while degrading the error management scheme used for that unit of memory based on the number of extra bits available after the spare bit's use.

Each memory manager has eight independent banks of memory, as shown at 102. Each bank is able to operate separately, providing a very high memory bandwidth. Each bank comprises two sub-banks that are 16 memory reference entries deep, and each sub-bank comprises an atomic memory operation cache for 16 total atomic memory operation cache double words per memory manager. Each memory manager includes a single atomic memory operation functional unit 103, operable to perform atomic memory operations without requiring the operation result be calculated by a functional unit in the processor.

In operation, the processor receives a vector atomic memory operation at 201. It processes the atomic memory operation on a vector that is in one embodiment up to 128 data indexes stored in a vector mask register at 202. The processor pipeline in this example needs only one vector atomic memory operation instruction to complete atomic memory operations on all 128 memory locations, where performing the same task with traditional scalar atomic memory instructions would require 128 separate atomic memory operations to proceed through the processor pipeline.

At 203, the vector atomic memory operation is issued to the memory controller as a series of atomic memory operations. In an alternate embodiment, the atomic memory operation is issued to the memory controller, and is processed as a series of atomic memory operations in the memory controller. In this example, the atomic memory operations are performed in the atomic memory operation functional unit at 204, and the result is written back to memory at 205. A completion signal is returned to the processor at 206, and if the atomic memory operation is a fetch operation, the result of the operation is also sent back to the processor at 207.

Other embodiments of a vector atomic memory operation will operate using different memory architectures, processor architectures, and functional units. For example, in an alternate embodiment, the atomic memory operation functional unit, the memory manager, or other such functions are a part of the processor and not an external device. Addressing the vector elements need not use a base address and stride or index, but can use any other suitable method of identifying a vector of data in alternate embodiments.

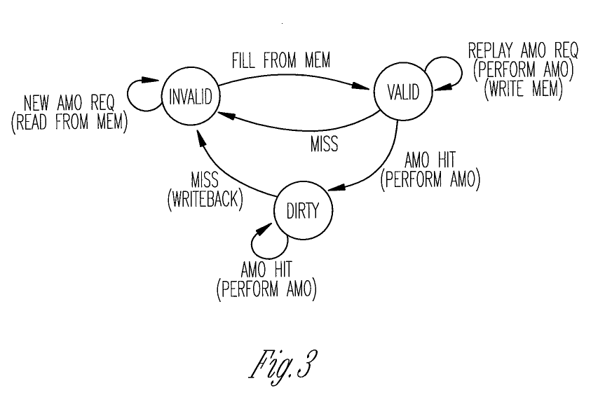

Consistency in the atomic memory operation cache of each bank 102 is maintained with main memory in a further embodiment as shown in FIG. 3. The AMO cache is a single Dword cache with a simple protocol to maintain consistency with main memory. A 23-bit tag PA[38:16] is used to match the cache contents with the requesting address. The cache state is defined by the set {Invalid, Valid, Dirty}.

Operation of the AMO cache is illustrated by the state diagram of FIG. 3. An AMO request arrives at the head of the bank queue and compares the AMO cache tag with the requesters address. If it is a hit, the AMO is performed and the cache data is updated. On an AMO miss, the AMO control unit will schedule a writeback (if state was Dirty) then update the AMO cache tag and schedule a memory read operation to fill the AMO cache. However, the requesting AMO is not dequeued from the front of the bank. When the read operation returns from the DDR2 devices, the cache fill operation transitions the state from Invalid to Valid. The original AMO request is replayed and the AMO is performed with the result of the AMO written to main memory. If another AMO request to the same address finds the cache state Valid it will perform the AMO operation, write the result to the AMO cache and transition to the Dirty state. So, the write to main memory is only performed initially and all subsequent AMO hits will update only the cached data.

Requests that miss in the Dirty state will perform a writeback to main memory (i.e. the MM must evict the current contents, and fill the AMO cache with the newly requested data). The evicted AMO data is moved aside into an eviction buffer, where it will await a write bus cycle to writeback the data to main memory. The read operation for the allocating AMO will be scheduled. The writeback operation may occur before the read operation for the allocating AMO, depending on if the current memory bus cycle is a read or write cycle. The AMO operation must remain at the head of the bank queue until the AMO is satisfied. Therefore, all subsequent requests to the bank will block behind the AMO. Once the AMO fill data (read operation) returns from the memory device, the AMO operation will hit out of the AMO cache and perform the AMO just as it does for any other AMO cache hit.

An AMO operation can hit in the AMO cache when there is an exact match of the AMO cache tag. The AMO cache tag is formed as a concatenation of {PA[38:16], mask}. Since there is an AMO cache at each bank, PA[15:12] are implicit. There are three different cases to handle on an exact match in the AMO cache: 1) an AMO operation, 2) a read operation, and 3) a write. The simplest case is when an AMO operation hits in the cache, it simply uses the dword value in the cache, performs the AMO, and stores the result in the cache data. To simplify the logic, this example allows only single dword read operations to hit out of the AMO cache. Read requests for multiple dwords (i.e. a partial match) will first flush the AMO cache, then perform the read from main memory rather than try to merge the results from memory with the value in the cache data. Finally, all writes that are a (exact or partial) match in the AMO cache must first flush the AMO cache data and then perform the write. Flushing the AMO cache prior to performing the write request ensures that writes to the same address are ordered consistent with a total store ordering

The protocol illustrated in FIG. 3 allows the system to bypass the AMO cache and still perform AMOs. This is accomplished by transitioning to the Invalid state (from the Valid state) immediately after replaying the AMO request at the head of the bank queue. So, the main memory is always consistent, since each AMO will perform a read-modify-write operation to main memory.

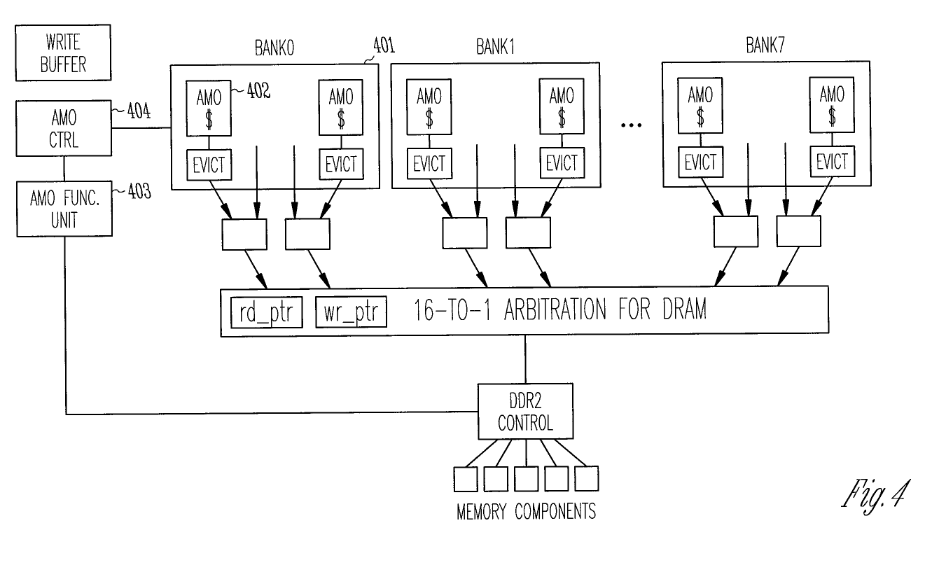

FIG. 4 is an alternate block diagram of a computerized system memory manager supporting vector atomic memory operations, consistent with an example embodiment of the invention. Each memory manager has eight independent memory manager banks 401. Each memory manager bank has two separate atomic memory operation caches 402, capable of sustaining an atomic memory operation every other word clock cycle. Each bank 401's two sub-banks are 16 entries deep, such that there are 16 total queues in the memory manager, each supporting up to 16 entries.

A single atomic memory operation functional unit 403 is coupled to the 16 atomic memory operation caches 402 via an atomic memory operation controller 404. This architecture allows for efficient handling of large numbers of atomic memory operations, such as where a vector atomic memory operation is executed in the memory controller as a series of atomic memory operations.

The examples presented here show how vector atomic memory operations can be implemented in an example processor and memory management unit. In other examples, various functions described herein will operate in the processor, the memory management unit, or be excluded from a particular implementation. The examples presented here are therefore only examples of certain embodiments of the invention, and do not limit or fully define the invention. Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A processor, comprising:
an instruction decoder operable to process a vector atomic memory operation instruction.

2. The processor of claim 1, wherein the vector atomic memory operation is converted to a series of atomic memory operations to be performed in a memory manager.

3. The processor of claim 2, further comprising a memory manager comprising an atomic memory operation functional unit operable to process a vector atomic memory operation.

4. The processor of claim 3, wherein the atomic memory operation functional unit is shared among multiple banks of memory.

5. The processor of claim 3, wherein the memory manager is further operable to return a completion notification to the processor upon completion of atomic memory operations.

6. The processor of claim 3, wherein the memory manager is further operable to return a result to the processor for fetch atomic memory operations.

7. A processor, operable to execute a vector atomic memory operation.

8. The processor of claim 7, wherein the vector atomic memory operation is executed by issuing a series of atomic memory operations to be performed in a memory controller.

9. The processor of claim 8, wherein the memory controller comprises an atomic memory operation functional unit.

10. The processor of claim 8, wherein the memory controller is further operable to return a result for fetch atomic memory operation.

11. A method of operating a computer processor, comprising:
an instruction decoder operable to process a vector atomic memory operation instruction.

12. The method of operating a computer processor of claim 11, wherein the vector atomic memory operation is converted to a series of atomic memory operations to be performed in a memory manager.

13. The method of operating a computer processor of claim 12, further comprising a memory manager comprising an atomic memory operation functional unit operable to process a vector atomic memory operation.

14. The method of operating a computer processor of claim 13, wherein the atomic memory operation functional unit is shared among multiple banks of memory.

15. The method of operating a computer processor of claim 13, wherein the memory manager is further operable to return a completion notification to the processor upon completion of atomic memory operations.

16. The method of operating a computer processor of claim 13, wherein the memory manager is further operable to return a result to the processor for fetch atomic memory operations.

17. A method of operating a computer processor, comprising executing a vector atomic memory operation.

18. The method of operating a computer processor of claim 17, wherein the vector atomic memory operation is executed by issuing a series of atomic memory operations to be performed in a memory controller.

19. The method of operating a computer processor of claim 18, wherein the memory controller comprises an atomic memory operation functional unit.

20. The method of operating a computer processor of claim 18, further comprising returning a result for a fetch atomic memory operation from the memory controller.
